(19) United States
(12) Patent Application Publication
(10) Pub. No.: US 2026/0371322 A1
(43) Pub. Date: Nov. 19, 2026

(54) FLEXIBLE NETWORK ENTITY SLEEP INDICATIONS IN WIRELESS COMMUNICATIONS SYSTEMS

(71) Applicant: QUALCOMM Incorporated, San Diego, CA (US)

(72) Inventors: Navid ABEDINI, Basking Ridge, NJ (US); Junyi LI, Greentown, PA (US)

(21) Appl. No.: 19/578,669

(22) Filed: Mar. 25, 2026

Related U.S. Application Data
(60) Provisional application No. 63/807,429, filed on May 16, 2025.

(51) Int. Cl. H04W 72/0446; H04W 52/02; H04W 72/23

(52) U.S. Cl. CPC H04W 72/0446; H04W 52/0203; H04W 72/23

(57) ABSTRACT

This disclosure provides methods, components, devices and systems for flexible network entity sleep indications in wireless communications systems. For example, a network entity may transmit first control signaling indicating multiple time resources and may transmit second control signaling indicating one or more time resources of the multiple time resources and indicating configuration information indicative of the availability of the network entity to communicate during the one or more time resources. In some examples, the configuration information may indicate, for each time resource of the one or more time resources, whether frequency resources are active during the time resource, whether spatial resources are active during the time resource, whether one or more transmission-reception points are active during the time resource, whether communications at the network entity are active during the time resource, or any combination thereof.

### CROSS REFERENCE

The present Application for Patent claims benefit of U.S. Provisional Patent Application No. 63/807,429 by ABEDINI et al., entitled “FLEXIBLE NETWORK ENTITY SLEEP INDICATIONS IN WIRELESS COMMUNICATIONS SYSTEMS,” filed May 16, 2025, which is assigned to the assignee hereof, and expressly incorporated herein.

### TECHNICAL FIELD

This disclosure relates generally to wireless communication, and more specifically to systems, devices, methods, and techniques associated with flexible network entity sleep indications in wireless communications systems.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

In some wireless communications systems, wireless devices may operate according to discontinuous communications. For example, a wireless device may transition between an active mode (e.g., a high power mode) and an inactive mode (e.g., a low power mode) to support power savings. In some cases, the wireless device may have reduce communications capabilities while operating in the inactive mode, for example due to deactivating one or more communication components.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving first control signaling indicating a set of multiple time resources for communicating with a network entity, receiving second control signaling indicating one or more time resources of the set of multiple time resources in which the network entity is operating in a reduced capability state and indicating configuration information that identifies whether the network entity is available for communicating during the one or more time resources, and communicating one or more messages with the network entity during at least a subset of the set of multiple time resources in accordance with the second control signaling.

A UE for wireless communications is described. The UE may include a processing system that includes processor circuitry and memory circuitry that stores code. The processing system may be configured to cause the UE to receive first control signaling indicating a set of multiple time resources for communicating with a network entity, receive second control signaling indicating one or more time resources of the set of multiple time resources in which the network entity is operating in a reduced capability state and indicating configuration information that identifies whether the network entity is available for communicating during the one or more time resources, and communicate one or more messages with the network entity during at least a subset of the set of multiple time resources in accordance with the second control signaling.

Another UE for wireless communications is described. The UE may include means for receiving first control signaling indicating a set of multiple time resources for communicating with a network entity, means for receiving second control signaling indicating one or more time resources of the set of multiple time resources in which the network entity is operating in a reduced capability state and indicating configuration information that identifies whether the network entity is available for communicating during the one or more time resources, and means for communicating one or more messages with the network entity during at least a subset of the set of multiple time resources in accordance with the second control signaling.

A non-transitory computer-readable medium storing code for wireless communications is described. The code may include instructions executable by one or more processors to receive first control signaling indicating a set of multiple time resources for communicating with a network entity, receive second control signaling indicating one or more time resources of the set of multiple time resources in which the network entity is operating in a reduced capability state and indicating configuration information that identifies whether the network entity is available for communicating during the one or more time resources, and communicate one or more messages with the network entity during at least a subset of the set of multiple time resources in accordance with the second control signaling.

In some examples of the method, UEs, and non-transitory computer-readable medium described herein, the second control signaling includes a first control message that indicates the configuration information; or the second control signaling includes a second control message that schedules the one or more messages and indicates the configuration information.

In some examples of the method, UEs, and non-transitory computer-readable medium described herein, the first control signaling indicates, for a first time resource of the set of multiple time resources, first configuration information indicating a first availability of the network entity during the first time resource and the second control signaling indicates, for the first time resource, second configuration information indicating a second availability of the network entity during the first time resource, where, communicating the one or more messages with the network entity may include operations, features, means, or instructions for communicating the one or more messages with the network entity during the first time resource in accordance with the second availability based on the second configuration information indicating to override the first configuration information.

Some examples of the method, UEs, and non-transitory computer-readable medium described herein may further include operations, features, means, or instructions for receiving, prior to reception of the second control signaling, third control signaling including second configuration information indicating a first availability of the network entity during a first time resource of the one or more time resources, where: the second control signaling indicates, for the first time resource, a second availability of the network entity during the first time resource; and the second control signaling includes a priority flag indicating whether the second availability of the network entity overrides the first availability of the network entity during the first time resource.

In some examples of the method, UEs, and non-transitory computer-readable medium described herein, communicating the one or more messages with the network entity may include operations, features, means, or instructions for communicating a first message scheduled during the first time resource based on one or more rules for communicating signaling when the network entity may be unavailable.

In some examples of the method, UEs, and non-transitory computer-readable medium described herein, the configuration information indicates and the method, apparatuses, and non-transitory computer-readable medium may include further operations, features, means, or instructions for canceling a feedback message scheduled for the first time resource based on the configuration information indicating that the network entity may be unavailable during at least the portion of the first time resource, where communicating the one or more messages with the network entity includes transmitting the feedback message during a second time resource of the set of multiple time resources based on the configuration information indicating that the network entity may be available during the second time resource.

In some examples of the method, UEs, and non-transitory computer-readable medium described herein, the first control signaling indicates, for a first time resource of the set of multiple time resources, a slot offset for the first time resource, a starting symbol for the first time resource, a duration for the first time resource, a periodicity of the first time resource, or any combination thereof.

In some examples of the method, UEs, and non-transitory computer-readable medium described herein, the first control signaling, or the second control signaling, or both indicate, for a first time resource of the set of multiple time resources, one or more frequency resources for communicating during the first time resource, one or more beams for communicating during the first time resource, one or more transmission-reception points for communicating during the first time resource, or any combination thereof.

In some examples of the method, UEs, and non-transitory computer-readable medium described herein, the configuration information indicates, for a first time resource of the one or more time resources, whether transmissions, receptions, or both may be active at the network entity during the first time resource, whether one or more beams may be active for communicating during the first time resource, whether one or more transmission-reception points of the network entity may be active for communicating during the first time resource, or any combination thereof.

Some examples of the method, UEs, and non-transitory computer-readable medium described herein may further include operations, features, means, or instructions for communicating, prior to reception of the second control signaling, the one or more messages during a first time resource of the one or more time resources, where communicating the one or more messages with the network entity includes communicating the one or more messages during a second time resource of the set of multiple time resources based on the configuration information indicating that the network entity may be unavailable during the first time resource and the configuration information indicating that the network entity may be available during the second time resource.

A method for wireless communications by a network entity is described. The method may include transmitting first control signaling indicating a set of multiple time resources for communications at the network entity, transmitting second control signaling indicating one or more time resources of the set of multiple time resources in which the network entity is operating in a reduced capability state and indicating configuration information that identifies whether the network entity is available for communicating during the one or more time resources, and communicating one or more messages during at least a subset of the set of multiple time resources in accordance with the second control signaling.

A network entity for wireless communications is described. The network entity may include a processing system that includes processor circuitry and memory circuitry that stores code. The processing system may be configured to cause the network entity to transmit first control signaling indicating a set of multiple time resources for communications at the network entity, transmit second control signaling indicating one or more time resources of the set of multiple time resources in which the network entity is operating in a reduced capability state and indicating configuration information that identifies whether the network entity is available for communicating during the one or more time resources, and communicate one or more messages during at least a subset of the set of multiple time resources in accordance with the second control signaling.

Another network entity for wireless communications is described. The network entity may include means for transmitting first control signaling indicating a set of multiple time resources for communications at the network entity, means for transmitting second control signaling indicating one or more time resources of the set of multiple time resources in which the network entity is operating in a reduced capability state and indicating configuration information that identifies whether the network entity is available for communicating during the one or more time resources, and means for communicating one or more messages during at least a subset of the set of multiple time resources in accordance with the second control signaling.

A non-transitory computer-readable medium storing code for wireless communications is described. The code may include instructions executable by one or more processors to transmit first control signaling indicating a set of multiple time resources for communications at the network entity, transmit second control signaling indicating one or more time resources of the set of multiple time resources in which the network entity is operating in a reduced capability state and indicating configuration information that identifies whether the network entity is available for communicating during the one or more time resources, and communicate one or more messages during at least a subset of the set of multiple time resources in accordance with the second control signaling.

### BRIEF DESCRIPTION OF THE DRAWINGS

FIG. 1 shows an example of a wireless communication system.

FIG. 2 shows an example of a signaling configuration that supports flexible network entity sleep indications in wireless communications systems.

FIG. 3 shows an example of a process flow that supports flexible network entity sleep indications in wireless communications systems.

FIG. 4 shows a block diagram of a processing system that supports flexible network entity sleep indications in wireless communications systems.

FIG. 5 shows a diagram of a system including a device that supports flexible network entity sleep indications in wireless communications systems.

FIG. 6 shows a block diagram of a processing system that supports flexible network entity sleep indications in wireless communications systems.

FIG. 7 shows a diagram of a system including a device that supports flexible network entity sleep indications in wireless communications systems.

FIGS. 8 and 9 show flowcharts illustrating methods that support flexible network entity sleep indications in wireless communications systems.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, wireless device may operating according to one or more discontinuous communications schemes. For example, a network entity may operate according to a discontinuous reception (DRX) and discontinuous transmission (DTX) configuration (e.g., a DRX/DTX configuration), where the network entity may be active for communications during one or more first time resources and inactive for communications during one or more second time resources. In some examples, entering an inactive duration of the DRX/DTX configuration may impact scheduled communications, such as uplink signals received at the network entity or downlink signals transmitted by the network entity. However, signaling to indicate inactive durations and handle impacted communications may lack flexibility, thereby limiting an ability of the network entity to transition to the inactive mode and improve power savings.

Aspects of the subject matter described in this disclosure relate to signaling by a network entity to inform other wireless devices of an availability of the network entity during one or more time resources. For example, the network entity may transmit first control signaling indicating multiple time resources (e.g., radio resource control (RRC) signaling including one or more lists of time resources) and may transmit second control signaling indicating one or more time resources of the multiple time resources and indicating configuration information indicative of the availability of the network entity to communicate during the one or more time resources. In some examples, the configuration information may indicate, for each time resource of the one or more time resources, whether frequency resources are active during the time resource, whether spatial resources (e.g., beams) are active during the time resource, whether one or more transmission-reception points (TRPs) are active during the time resource, whether communications (e.g., transmission and/or receptions) at the network entity are active during the time resource, or any combination thereof. In some cases, the configuration information may indicate whether the availability of the network entity overrides previously-indicated availability (e.g., indicated via the RRC signaling or different control signaling). A user equipment (UE) may receive the configuration information and may communicate messages according to the availability of the network entity. For example, the UE may cancel at least a portion of a scheduled message when the network entity is unavailable, may defer transmissions (e.g., feedback messages or other uplink messages) to a later time resource when the network entity is available, or both.

Particular aspects of the subject matter described in this disclosure can be implemented to realize one or more of the following potential advantages. In some examples, by communicating the configuration information identifying whether the network entity is available for communicating during one or more time resources, the described techniques can be used to improve power savings at the network entity and limit and impact of the network entity transitioning to an inactive mode on scheduled communications.

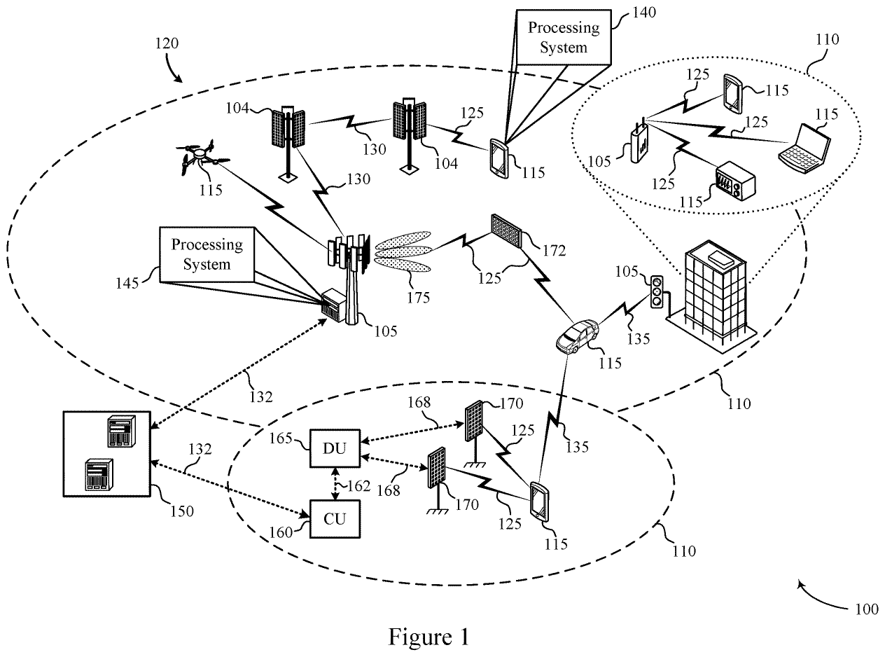

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, where the device may provide HARQ feedback in a specific slot for data received via a previous symbol of the slot. In some other examples, the device may provide HARQ feedback via a subsequent slot or according to some other time interval. Beamforming techniques may include analog beamforming, for which at least some signal processing (such as phase shifting, amplification, signal combination) is performed in an analog domain (such as using analog components, including analog phase shifters and amplifiers, for processing respective signals of individual antenna elements). Additionally (such as in accordance with hybrid beamforming), or alternatively, beamforming techniques may include digital beamforming, for which at least some signal processing is performed in a digital domain (such as using digital processing techniques for processing respective signals of individual antenna elements).

A network entity 105 or a UE 115 may use beam sweeping techniques as part of beamforming operations. For example, a network entity 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a specific receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105, a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by receiving according to different receive beamforming weight sets applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Other techniques for reducing power consumption at UEs 115 may include a low-power wake up radio (LP-WUR). The LP-WUR may receive one or more signals while a UE 115 is in a sleep mode. For example, the LP-WUR may receive low-power wakeup signal (LP-WUS) or low-power synchronization signal (LP-SS) transmissions. The LP-WUS transmissions may indicate for the UE 115 to transition to an awake state and power on a main radio to perform wireless communications with another device (e.g., with the network entity 105). The LP-SS transmissions may be used by the LP-WUR for time and frequency synchronizations or channel measurements for the UE 115.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

Devices of the wireless communication system 100 may be configured to support one or more aspects of the described techniques for flexible network entity sleep indications in wireless communications systems. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support signaling by a network entity 105 to inform other wireless devices (e.g., UEs 115) of an availability of the network entity 105 during one or more time resources. For example, the network entity 015 may transmit first control signaling indicating multiple time resources (e.g., RRC signaling including one or more lists of time resources) and may transmit second control signaling indicating one or more time resources of the multiple time resources and indicating configuration information indicative of the availability of the network entity 105 to communicate during the one or more time resources. In some examples, the configuration information may indicate, for each time resource of the one or more time resources, whether frequency resources are active during the time resource, whether spatial resources (e.g., beams) are active during the time resource, whether one or more TRPs of the network entity 105 are active during the time resource, whether communications (e.g., transmission and/or receptions) at the network entity 105 are active during the time resource, or any combination thereof. In some cases, the configuration information may indicate whether the availability of the network entity 105 overrides previously-indicated availability (e.g., indicated via the RRC signaling or different control signaling). A UE 115 may receive the configuration information and may communicate messages according to the availability of the network entity 105. For example, the UE 115 may cancel at least a portion of a scheduled message when the network entity is unavailable, may defer transmissions (e.g., feedback messages or other uplink messages) to a later time resource when the network entity 105 is available, or both.

Particular aspects of the subject matter described in this disclosure can be implemented to realize one or more of the following potential advantages. In some examples, by communicating the configuration information identifying whether the network entity 105 is available for communicating during one or more time resources, the described techniques can be used to improve power savings at the network entity 105 and limit and impact of the network entity 105 transitioning to an inactive mode on scheduled communications.

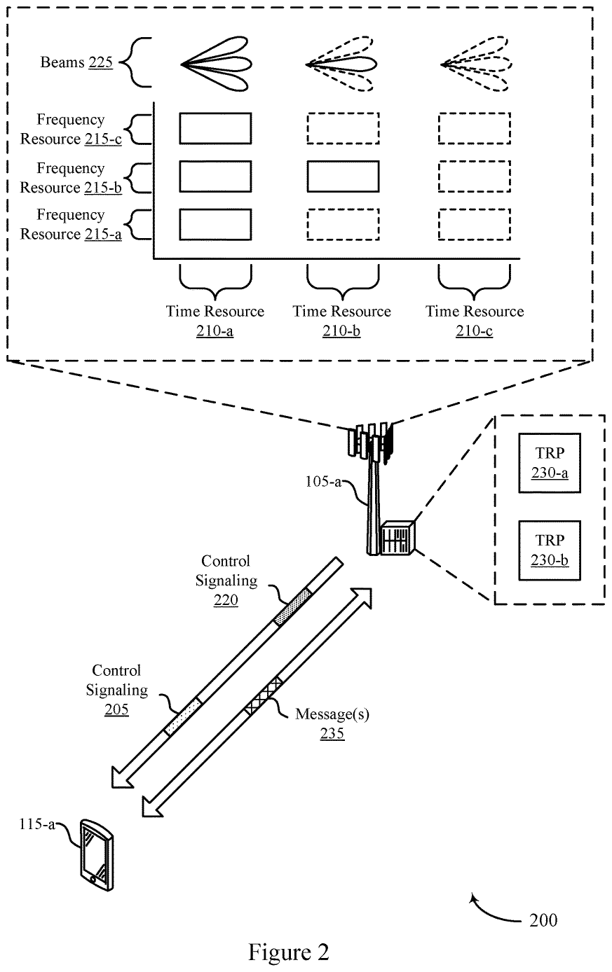

FIG. 2 shows an example of a signaling configuration 200 that supports flexible network entity sleep indications in wireless communications systems. The signaling configuration 200 may implement, or be implemented by, one or more aspects of the wireless communications system 100. For example, the signaling configuration 200 illustrates signaling between a UE 115-a and a network entity 105-a, which may be examples of corresponding devices described with reference to FIG. 1. The signaling configuration 200 may support the network entity 105-a operating in a reduced capability state during one or more time resources. For example, the network entity 105-a may operate according to a DRX/DTX configuration where the network entity 105-a may be active for communications during one or more first time resources and at least partially inactive for communications during one or more second time resources, which may support power savings at the network entity 105-a. In some cases, the signaling configuration 200 may support the network entity 105-a transmitting control signaling indicating the availability of the network entity 105-a during one or more time resources, which may support further power savings at the network entity 105-a while mitigating impacts on scheduled communications.

In some cases, the network entity 105-a may indicate, to the UE 115-a, a DRX/DTX configuration of the network entity 105-a (e.g., via higher-layer control signaling, such as RRC). For example, the network entity 105-a may indicate a periodic pattern of active durations and inactive durations for communicating with the network entity 105-a. During the inactive durations, one or more wireless channels or signals may be canceled for communicating with the network entity 105-a. For example, during an inactive duration of a DTX configuration at the network entity 105-a, PDCCH messages may be canceled, semi-persistently scheduled (SPS) messages (e.g., SPS PDSCH messages) may be canceled, or both. Additionally, or alternatively, during an inactive duration of a DRX configuration at the network entity 105-a, scheduling request messages may be canceled, configured grant (CG) PUSCH messages may be canceled, or both. In some examples, the network entity 105-a may transmit subsequent messages (e.g., via lower-layer control signaling, such as a DCI or a media access control-control element (MAC-CE)) to the UE 115-a to activate or deactivate the DRX/DTX configuration. However, such a DRX/DTX configuration may be relatively static, which may limit opportunities for the network entity 105-a to enter a sleep mode (e.g., an inactive or partially inactive mode). For example, the network entity 105-a may identify an upcoming opportunity to enter an inactive mode (which may be referred to as a micro sleep) that is outside of the DRX/DTX configuration (e.g., resources during an active duration of the DRX/DTX configuration), but may be unable to inform UEs 115 of the transition to the inactive mode.

Techniques described herein provide for the network entity 105-a to inform the UE 115-a of an availability of the network entity 105-a during one or more time resources that the network entity 105-a operates in a reduced capability state (e.g., an inactive or partially inactive mode). The network entity 105-a may transmit control signaling 205 (which may be referred to as first control signaling) to the UE 115-a that indicates multiple time resources 210 (e.g., slots, mini-slots, sub-slots, collections of symbols). In some examples, the control signaling 205 may be an RRC message that configures the multiple time resources 210, such as a time resource 210-a, a time resource 210-b, and a time resource 210-c. For example, the control signaling 205 may indicate a list of the time resources 210 (e.g., a list of K time resources 210) or may indicate multiple lists of time resources 210 (e.g., a set of Y lists of time resources 210, each list including Z time resources 210). The control signaling 205 may define each time resource 210 according to a slot offset value, a starting symbol, a duration (e.g., a quantity of slots, a quantity of symbols), a periodicity, or any combination thereof.

In some cases, the network entity 105-a may transmit control signaling 220 (which may be referred to as a second control signaling) to the UE 115-a indicating one or more time resources 210 of the multiple time resources 210 (e.g., at least a subset of the time resources 210 indicated by the control signaling 205) in which the network entity 105-a is operating in a reduced capability state, such as an inactive mode. The control signaling 220 may indicate configuration information that identifies whether the network entity 105-a is available for communicating during the one or more time resources 210. In some examples, the control signaling 220 may be an example of a DCI message or a MAC-CE message (e.g., dynamic control signaling). Alternatively, the control signaling 220 may be an example of an RRC message and, in some cases, may be part of the control signaling 205 (e.g., the same RRC message may configure the multiple time resources 210 and may indicate the subset of time resources 210 that the network entity is operating in the reduced capability state).

In some examples, the control signaling 205, the control signaling 220, or both may associate each of the time resources 210 with one or more frequency resources 215 (e.g., one or more cells, one or more sub-bands, one or more sub-carriers, or other frequency subcomponents) of a bandwidth for the network entity 105-a, such as a frequency resource 215-a, a frequency resource 215-b, and a frequency resource 215-c. Additionally, or alternatively, the control signaling 205, the control signaling 220, or both may associate each of the time resources 210 with one or more beams 225 (e.g., spatial resources) of the network entity 105-a, one or more TRPs 230 associated with the network entity 105-a, or any combination thereof. For example, the network entity 105-a may include or otherwise manage operation of a TRP 230-a and a TRP 230-b, and may indicate (e.g., via the control signaling 205 and/or the control signaling 220) whether the TRP 230-a, the TRP 230-b, or both are associated with communications during each time resource 210. In some examples, the TRPs 230 may be co-located, and the beams 225 may be associated with each of the TRPs 230. Alternatively, the TRPs 230 may be non-co-located, and the network entity 105-a may indicate respective beams 225 that are associated with respective TRPs 230 for communications during each time resource 210.

The configuration information included in the control signaling 220 may indicate the availability of the network entity 105-a during the one or more time resources 210 indicated by the control signaling 220 (which may be referred to as a sleep indication) while the network entity 105-a operates a reduced capability state. For example, the control signaling 220 may indicate the time resource 210-b and the configuration information may indicate, for the time resource 210-b, whether transmissions, receptions, or both are active at the network entity 105-a during the time resource 210-b. As an example, the configuration information may indicate, for the time resource 210-b, that transmissions by the network entity 105-a are canceled, that receptions at the network entity 105-a are canceled, that both transmissions and receptions by the network entity 105-a are canceled, or that neither transmissions or receptions by the network entity 105-a are canceled (e.g., the network entity 105-a is active). As described herein, the reduced capability state may refer to one or more communication features of the network entity 105-a being inactive or unavailable, such as the network entity 105-a having at least a portion of frequency resources (e.g., bandwidths, sub-bands, sub-carriers, cells) inactive for communications, having one or more of the TRPs 230 inactive for communications, having one or more beams 225 inactive for communications, having one or more transmissions, receptions, or both canceled or inactive, or any combination thereof, among other examples.

Additionally, or alternatively, the configuration information may indicate whether one or more frequency resources 215 are active for communicating during the time resource 210-b, whether one or more beams 225 are active for communicating during the time resource 210-b, whether one or more of the TRPs 230 are active for communicating during the time resource 210-b, or any combination thereof. For example, the configuration information may indicate that, during the time resource 210-b, the frequency resource 215-a is inactive for communications, the frequency resource 215-b is active for communications, and the frequency resource 215-c is inactive for communications. Additionally, or alternatively, the configuration information may indicate, during the time resource 210-b, whether one or more cells are active or inactive, whether one or more sub-carriers of a bandwidth are active (e.g., sub-components of the frequency resources 215, other frequency regions of the bandwidth), or both. The configuration information may further indicate that a portion of the beams 225 are inactive during the time resource 210-b (e.g., at least one beam 225 may remain active) and that at least one of the TRP 230-a and the TRP 230-b are inactive during the time resource 210-b.

The control signaling 220 may additionally indicate the time resource 210-c, and the configuration information may indicate the availability of network entity 105-a during the time resource 210-c. For example, the configuration information may indicate that the network entity 105-a is fully inactive during the time resource 210-c, such as by indicating that transmissions and receptions by the network entity 105-a are canceled during the time resource 210-c, each of the frequency resources 215 are inactive during the time resource 210-c, each of the beams 225 are inactive during the time resource 210-c, and each of the TRPs 230 are inactive during the time resource 210-c.

The control signaling 220 may be an example of various types of control messages. As a first example, the control signaling 220 may be a DCI message. In such examples, the DCI message may indicate a list of one or more time resources 210 (e.g., a list of N time resources 210, where N may be an RRC configured value) of the time resources 210 configured by the control signaling 205. For example, the control signaling 205 may configure a list of K time resources 210, and the DCI message may indicate one or N indices of the list of time resources 210, where N may be less than or equal to K. The DCI message may include the configuration information for the one or more time resources 210 to indicate whether the network entity 105-a is available for communicating during the one or more time resources 210. If the control signaling 220 indicates the association between the one or more time resources 210 and the frequency resources 215, the beams 225, the TRPs 230, or any combination thereof, the DCI message may include additional indices that refer to other lists of RRC configured values (e.g., referring to RRC configured lists of frequency resources 215, lists of beams 225, lists of TRPs 230, or any combination thereof). In some examples, the UE 115-a may determine a time-domain location of the one or more time resources 210 according to a slot offset value. For example, the UE 115-a may determine the time-domain location of a time resource 210 according to a slot offset n+k, where n may refer to a slot when the UE 115-a receives the DCI message and k may refer to an offset value (e.g., a quantity of slots), which may be defined by a capability of the UE 115-a and/or configured or indicated by the network entity 105-a.

In some examples, the DCI message may be generated according to a new DCI format or type of DCI that is for communicating the configuration information indicating the availability of the network entity 105-a during the one or more time resources 210 when the network entity 105-a operates in the reduced capability state. For example, the DCI message may be UE-specific (e.g., specific to the UE 115-a), group-common (e.g., for a group of UEs 115 including the UE 115-a), or both. Alternatively, the DCI message may be a DCI that schedules communications (e.g., a DCI including an uplink grant and/or a downlink grant), and the configuration information for the one or more time resources 210 may be included (e.g., carried alongside, piggy-backed, appended) with the scheduling information. In such examples, the DCI message may include additional information elements (e.g., flags) for indicating the one or more time resources 210 and the configuration information.

As a second example, the control signaling 220 may be a MAC-CE. In such examples, the MAC-CE may indicate one or more lists of time resources 210 configured by the control signaling 205. For example, the control signaling 205 may indicate Y lists of time resources 210 (e.g., up to a preconfigured maximum value of Y′) where each list may include Z time resources 210 (e.g., up to a preconfigured maximum value of Z′), and the MAC-CE may indicate one or more of the Y lists. The MAC-CE may include or indicates the configuration information for the one or more lists of time resources 210 to indicate whether the network entity 105-a is available for communicating during the one or more time resources 210. In some examples, the MAC-CE may configure at least a portion of the one or more time resources 210. For example, the control signaling 205 (e.g., an RRC signal) may include or indicate a first portion of the configuration information for the one or more time resources 210 and the MAC-CE (or a DCI carrying configuration information) may include or indicate a second (e.g., remaining) portion of the configuration information for the one or more time resources 210.

In some cases, the MAC-CE may update or override configuration information configured by the control signaling 205. For example, the control signaling 205 may include first configuration information indicating a first availability of the network entity 105-a during a time resource 210 and the control signaling 220 may include second configuration information indicating a second availability of the network entity 105-a during the time resource 210. In such examples, the UE 115-a may communicate during the time resource 210 according to the second availability indicated by the control signaling 220. For example, the control signaling 205 may indicate that the network entity 105-a is available for transmissions and receptions during the time resource 210-c and the control signaling 220 may indicate that the network entity 105-a is unavailable for transmissions, receptions, or both during the time resource 210-c. The UE 115-a may, during the time resource 210-c, refrain from transmitting messages to the network entity 105-a, not expect to receive messages from the network entity 105-a, or both based on the control signaling 220 indicating that the network entity 105-a is unavailable for transmissions, receptions, or both during the time resource 210-c.

In some examples, the UE 115-a may determine that the configuration information in the control signaling 220 overrides previous configuration information (e.g., in the control signaling 205, in third control signaling received prior to the control signaling 220) based on a priority flag included in the MAC-CE. For example, the priority flag may be associated with a list of time resources 210 indicated in the MAC-CE, where a value (or presence) of the priority flag may indicate whether the configuration information in the MAC-CE can override previously-indicated configuration information (e.g., a sleep indication in the control signaling 205, the third control signaling received prior to the control signaling 220, a previous RRC message, a previous DCI message).

As a third example, the control signaling 220 may be an RRC message. In such examples, the control signaling 220 may be received in a same or different transmission as the control signaling 205. For example, the RRC message may configure the multiple time resources 210 and include one or more periodic sleep indications (e.g., up to L periodic sleep indications). Each periodic sleep indication may include a list of one or more time resources 210 (e.g., up to J time resources 210) and each list may include, for a respective set of time resources 210, the configuration information indicating whether the network entity is available for communicating during the respective set of time resources 210. In some examples, the RRC message may include one or more priority flags associated with one or more lists of time resources 210. For example, a value (or presence) of a priority flag may indicate, for a respective list of time resources 210, whether the configuration information in the RRC message can override previously-indicated configuration information (e.g., a sleep indication in a previous DCI message, a previous MAC-CE, or both).

In some cases, the UE 115-a may communicate one or more messages 235 with the network entity 105-a during at least a subset of the time resources 210 in accordance with the control signaling 220. For example, the UE 115-a may identify inactive durations (e.g., off durations, sleep durations) of the network entity 105-a (e.g., when the network entity 105-a is in a reduced capability state) according to the configuration information included in the control signaling 220. The UE 115-a may restrict communications similarly to restrictions of a DRX/DTX configuration for the network entity 105-a, for example by expecting PDCCH and SPS-PDSCH messages from the network entity 105-a to be canceled, by refraining from transmitting scheduling requests and CG-PUSCH messages to the network entity 105-a, or both during inactive durations. Additionally, or alternatively, the UE 115-a may determine whether other uplink signals, other downlink signals, or both are supported or not supported during inactive durations. For example, whether additional downlink and uplink signals (or all downlink and uplink signals) are supported or not supported during inactive durations of the network entity 105-a may be based on the configuration information in the control signaling 220 (e.g., indicated by the network entity 105-a semi-statically or dynamically) or may be preconfigured.

In some cases, one or more of the messages 235 may be at least partially impacted (e.g., in the time domain and/or the frequency domain) by the inactive durations of the network entity 105-a. For example, a message 235 (e.g., a message to be transmitted or received by the network entity 105-a) may be scheduled during at least a portion of the time resource 210-c (e.g., at least partially overlapping with the time resource 210-c in the time domain and/or the frequency domain), and the configuration information included in the control signaling 220 may indicate that the network entity 105-a is inactive during the time resource 210-c. For example, a message 235 (e.g., a PDCCH transmission, a PDSCH transmission, a PUSCH transmission, or the like) may be scheduled for transmission by the network entity 105-a during at least a portion of the time resource 210-c via a previous control message (e.g., a scheduling DCI received by the UE 115-a prior to the control signaling 220), and the UE 115-a may identify, via the configuration information in the control signaling 220 (e.g., received after the scheduling DCI), that the network entity 105-a is inactive (or intends to be inactive) during the time resource 210-c, at frequency resources 215 scheduled for the PDCCH transmission, or both.

In such examples, the UE 115-a may determine whether at least a portion of the message 235 should be canceled. For example, the UE 115-a may determine, for the message 235 that is scheduled to overlap with at least a portion of the time resource 210-c in the time domain, whether the message 235 should be canceled (e.g., the whole message 235 is canceled), whether the message 235 will be performed without impact (e.g., a scheduled or ongoing message 235 may override the sleep indication, the UE 115-a may ignore the sleep indication if the message 235 has a threshold priority), or whether the message 235 should be partially canceled. For example, if a portion of the message 235 is canceled, a portion of uplink symbols or resource blocks may be dropped if the UE 115-a transmits the message 235, or a portion of downlink resources will not be used for communication if the network entity 105-a transmits the message 235, where the UE 115-a may perform rate matching around the portion of the downlink resources.

The UE 115-a may determine whether the message 235 should be canceled, partially canceled, or communicated without impact from the sleep indication based on a preconfigured specification, a configuration or indication from the network entity 105-a (e.g., a semi-static or dynamic configuration or indication), or according to one or more rules for communicating signaling when the network entity 105-a is unavailable. For example, the one or more rules may depend on a type (e.g., an importance or priority) or duration (e.g., a quantity of time domain symbols or frequency domain resource blocks) of the impacted message 235, a type of the sleep indication (e.g., whether the control signaling 220 is received via an RRC message, a DCI message, or a MAC-CE), a duration that the network entity 105-a is indicated to be unavailable, a portion of the message 235 that is impacted (e.g., an amount or percentage of the message 235 that is impacted by the sleep indication), a time domain location of the impact on the message 235 (e.g., whether the time resource 210-c overlaps with a beginning, middle, or end of a burst).

As an example, the UE 115-a may determine that a relatively important or high priority reference signal may override the sleep indication, while a less important or lower priority signal may be at least partially canceled. As another example, the UE 115-a may receive the sleep indication via an RRC message (e.g., a relatively static message) and may receive a DCI scheduling the message 235, and the UE 115-a may determine to communicate the message 235 (e.g., by scheduling the UE 115-a with a dynamic message that conflicts with the sleep indication, the network entity 105-a may be prepared to accommodate communication of the message 235). As another example, the UE 115-a may determine a percentage of the message 235 that is impacted by the sleep indication and compare the percentage to one or more thresholds, for example if more than 50% of the message 235 is impacted, the message 235 should be canceled, and if less than 10% of the message 235 is impacted, the message 235 should be communicated without impact, among other examples. As another example, if the impact on the message 235 is within a first or last portion of symbols of the message 235, the message 235 may be communicated (e.g., overriding the sleep indication), and if the impact on the message 235 is within a middle portion of symbols of the message 235, the message 235 may be canceled or partially canceled.

In some examples, the one or more messages 235 may include a feedback message transmitted by the UE 115-a (e.g., a HARQ feedback message indicating a reception status of a downlink message). For example, the UE 115-a may receive a DCI indicating one or more uplink resources for providing feedback that overlap with the time resource 210-c. The UE 115-a may receive the control signaling 220 indicating that the network entity 105-a is inactive during the time resource 210-c, and may determine to cancel the feedback message. In such examples, the UE 115-a may defer the feedback message until a time resource 210 when the network entity 105-a is available. For example, the UE 115-a may request resources for transmitting the deferred feedback message or the network entity 105-a may request or schedule the UE 115-a to transmit the deferred feedback message during a subsequent time resource 210 that the network entity 105-a is available (e.g., in an active mode, not in the reduced capability state).

In some examples, the UE 115-a may receive the control signaling 220 that indicates the network entity 105-a is unavailable during previous time resources 210 (e.g., the configuration information may be provided retrospectively). For example, the UE 115-a may perform one or more measurements during the time resource 210-b and the time resource 210-c, and may receive the control signaling 220 (e.g., after performing the measurements) indicating that the network entity 105-a is at least partially unavailable during the time resource 210-b and the time resource 210-c. In such examples, the UE 115-a may discard the one or more measurements based on the configuration information in the control signaling 220, for example to prevent such measurements from impacting channel quality calculations performed by the UE 115-a (e.g., since failed measurements may be due to the network entity 105-a being inactive, rather than channel degradation). As another example, the UE 115-a may transmit one or more messages 235 during the time resource 210-b and the time resource 210-c, and may receive the control signaling 220 (e.g., after transmitting the messages 235) indicating that the network entity 105-a is at least partially unavailable during the time resource 210-b and the time resource 210-c. In such examples, the UE 115-a may attempt to retransmit the one or more messages 235 during a subsequent time resource 210 that the network entity 105-a is available (e.g., the UE 115-a may request to be scheduled with resources for retransmitting the one or more messages 235 during the subsequent time resource 210).

In some cases, the control signaling 220 including the configuration information (e.g., the sleep indication, an indication of when the network entity 105-a operates in a reduced capability state) may be received via various channels or types of signals. For example, the network entity 105-a may transmit the control signaling 220 via a broadcast channel (e.g., in a system information block (SIB), via a new broadcast control or data channel, as a paging message). As another example, the control signaling 220 may be transmitted as a sequence of symbols or a reference signal. As another example, the control signaling 220 may be a low-power signal (e.g., a LP-WUR or LP-wakeup transmitter (LP-WUT) friendly signal). In this example, the network entity 105-a may include an LP-WUR (e.g., a relatively low-power radio in comparison to a main radio of the network entity 105-a) operable to modulate the control signaling 220 according to a relatively simple modulation scheme (e.g., on-off keying (OOK)), such that the network entity 105-a, the UE 115-a, or both may communicate the control signaling 220 without activating or turning on a main radio (e.g., further supporting power savings). In some cases, the network entity 105-a may indicate whether the sleep indication is applicable to a main radio, a LP-WUR/LP-WUT, or both. For example, the configuration information may indicate, for a time resource 210, whether the network entity 105-a is available for communicating LP signaling. Additionally, or alternatively, network entity 105-a may indicate, in the configuration information, which signals may be impacted or canceled. For example, the UE 115-a may assume or receive an indication of whether LP signals (e.g., LP-WUS, LP-SS, or other LP downlink signaling, as well as UL-WUS, RACH, LP reference signals, LP-PUCCH, or other LP uplink signaling) are canceled during time resources 210 indicated by the sleep indication.

In some examples, the network entity 105-a may transmit the control signaling 220 that includes configuration information for another network entity 105 (e.g., a neighboring cell). For example, the configuration information may include a sleep indication for communicating with another network entity 105 that is a neighbor to the network entity 105-a. In some examples, the UE 115-a may forward information indicative of the control signaling 205, the control signaling 220, or both to one or more other UEs 115 based on reception of the control signaling 220 (e.g., the UE 115-a may inform the other UEs 115 of the sleep indication).

In some examples, by communicating the configuration information identifying whether the network entity 105-a is available for communicating during one or more time resources, the described techniques can be used to improve power savings at the network entity 105-a and limit and impact of the network entity 105-a transitioning to an inactive mode on scheduled communications.

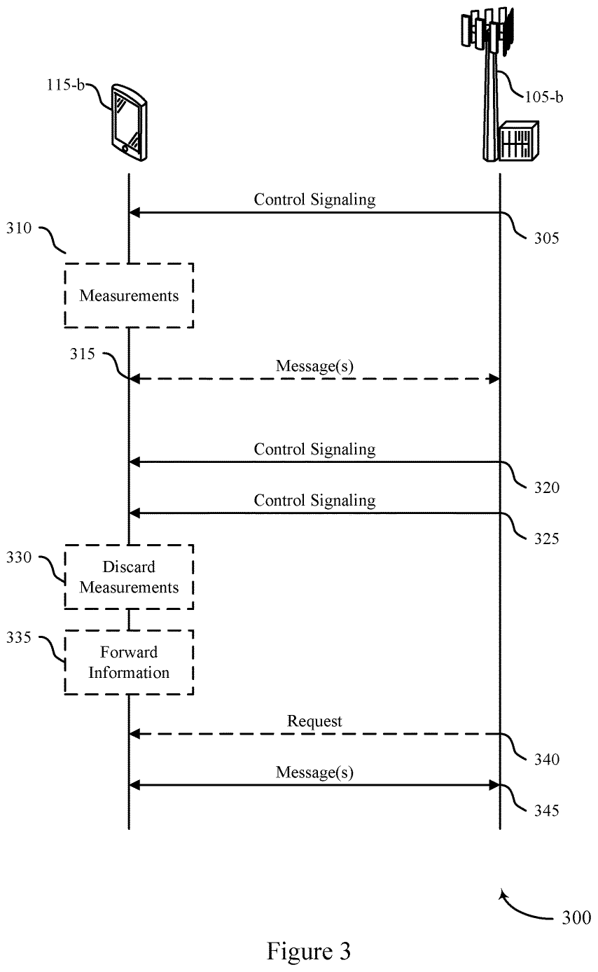

FIG. 3 shows an example of a process flow 300 that supports flexible network entity sleep indications in wireless communications systems. The process flow 300 may implement, or be implemented by, one or more aspects of the wireless communications system 100 and the signaling configuration 200. For example, the process flow 300 illustrates signaling between and operations by a UE 115-b and a network entity 105-b, which may be examples of corresponding devices described with reference to FIGS. 1 and 2. In some examples, the process flow 300 may support the network entity 105-b indicating one or more time resources where the network entity 105-b operates in a reduced capability state. Alternative examples of the following may be implemented, where some processes are performed in a different order than described or are not performed. In some cases, processes may include additional features not mentioned below, or further processes may be added.

At 305, the network entity 105-b may transmit, and the UE 115-b may receive, first control signaling. The first control signaling may indicate multiple time resources for communicating with the network entity 105-b. In some examples, the first control signaling may indicate, for a first time resource of the multiple time resources, a slot offset for the first time resource, a starting symbol for the first time resource, a duration for the first time resource, a periodicity of the first time resource, or any combination thereof. In some cases, the first control signaling may indicate for the first time resource, one or more frequency resources for communicating during the first time resource, one or more beams for communicating during the first time resource, one or more transmission-reception points for communicating during the first time resource, or any combination thereof. In some cases, the first control signaling may indicate, for a first time resource of the multiple time resources, first configuration information indicating a first availability of the network entity 105-b during the first time resource. In some cases, the first control signaling may be an RRC signal.

At 310, the UE 115-b may perform one or more measurements during one or more of the multiple time resources. For example, the UE 115-b may measure a quality of a channel between the UE 115-b and the network entity 105-b during the one or more time resources.

At 315, the UE 115-b and the network entity 105-b may communicate one or more messages during one or more of the multiple time resources. For example, the UE 115-b may transmit a feedback message during the one or more time resources. Additionally, or alternatively, the UE 115-b and the network entity 105-b may communicate one or more other messages (e.g., uplink signals and/or downlink signals) during the one or more time resources.

At 320, the network entity 105-b may transmit, and the UE 115-b may receive, control signaling (which may be referred to as third control signaling). The third control signaling may include second configuration information indicating a first availability of the network entity 105-b during a first time resource of the multiple time resources. For example, the second configuration information may be an example of a sleep indication as described herein. In some examples, the third control signaling may be an example of an RRC signal, a MAC-CE, or a DCI message.

At 325, the network entity 105-b may transmit, and the UE 115-b may receive, second control signaling. The second control signaling may indicate one or more time resources of the multiple time resources in which the network entity 105-b is operating in a reduced capability state and may indicate configuration information that identifies whether the network entity 105-b is available for communicating during the one or more time resources. For example, the configuration information may indicate, for a first time resource of the one or more time resources, whether at least a portion of uplink signaling, at least a portion of downlink signaling, or both, are supported or are not supported during the first time resource. In some cases, the second control signaling may indicate, for the first time resource, one or more frequency resources for communicating during the first time resource, one or more beams for communicating during the first time resource, one or more transmission-reception points for communicating during the first time resource, or any combination thereof. In some cases, the configuration information may indicate, for the first time resource, whether transmissions, receptions, or both are active at the network entity 105-b during the first time resource, whether one or more beams are active for communicating during the first time resource, whether one or more transmission-reception points of the network entity 105-b are active for communicating during the first time resource, or any combination thereof. In some cases, the second control signaling may be communicated via a broadcast channel, may be communicated via a sequence of symbols or a reference signal, may be communicated according to an OOK modulation scheme, may be communicated via a DCI message, a MAC-CE, or an RRC signal, or any combination thereof. In some cases, the configuration information may indicate, for the first time resource, whether the network entity 105-b is available for communicating LP signaling. In some cases, the UE 115-b may receive the second control signaling from a second network entity 105 (e.g., different from the network entity 105-b), where the second network entity 105 may be a neighbor to the network entity 105-b.

In some cases, the second control signaling may include a first control message that indicates the configuration information (e.g., a DCI configured to carry sleep indications) or the second control signaling may include a second control message that schedules the one or more messages and indicates the configuration information (e.g., a scheduling DCI including a sleep indication). In some cases, the configuration information may override previously received configuration information. For example, the first control signaling may indicate the first availability of the network entity 105-b for the first time resource and the second control signaling may indicate, in the configuration information, a second availability of the network entity 105-b during the first time resource, and the UE 115-b may communicate during the first time resource according to the second availability. Additionally, or alternatively, the third control signaling may indicate a first availability of the network entity 105-b during the first time resource and the second control signaling may indicate, for the first time resource, a second availability of the network entity 105-b and may include a priority flag indicating whether the second availability of the network entity 105-b overrides the first availability of the network entity 105-b during the first time resource.

At 330, the UE 115-b may discard the one or more measurements (e.g., performed at 310). For example, the UE 115-b may determine that the network entity 105-b is unavailable during the first time resource when the UE 115-b performed one or more measurements, and the UE 115-b may discard the one or more measurements based on receiving the second control signaling.

At 335, the UE 115-b may forward information related to the first control signaling, the second control signaling, or both. For example, the UE 115-b may transmit information indicative of the first control signaling, the second control signaling, or both to one or more second UEs 115 based on reception of the second control signaling (e.g., to inform the one or more second UEs 115 of the sleep indication).

At 340, the UE 115-b may receive a request to communicate a feedback message. For example, the UE 115-b may cancel a feedback message scheduled during the first time resource that the network entity 105-b is unavailable, and may defer the feedback message until a second time resource that the network entity 105-b is available (e.g., based on the configuration information in the second control signaling). In some cases, the UE 115-b may receive the request to communicate the feedback message and scheduling information for the feedback message based on the feedback message being canceled.

At 345, the UE 115-b and the network entity 105-b may communicate one or more messages during at least a subset of the multiple time resources in accordance with the second control signaling. In some cases, the UE 115-b may communicate the one or more messages with the network entity 105-b during the first time resources in accordance with the second availability (e.g., indicated by the second control signaling) based on the second availability overriding a previous availability (e.g., indicated by the first control signaling, the third control signaling, or both). In some cases, the UE 115-b may transmit the feedback message during a second time resource of the multiple time resources based on the configuration information indicating that the network entity 105-b is available during the second time resource (e.g., after canceling the feedback message initially scheduled for the first time resource when the network entity 105-b is unavailable). In some examples, if the configuration information indicates, for the first time resource, that the network entity 105-b is unavailable during at least a portion of the first time resource, the UE 115-b may communicate a first message scheduled during the first time resource based on one or more rules for communicating signaling when the network entity is unavailable (e.g., one or more rules to determine whether to cancel the first message, cancel a portion of the first message, or communicate the first message and override the sleep indication). For example, the one or more rules may be based on a type of the first message, a duration of the first message, a type of the second control signaling, a duration that the network entity is unavailable, a portion of the first message that overlaps with at least the portion of the first time resource that the network entity is unavailable, a location within the first time resource that the network entity is unavailable, or any combination thereof.

In some examples, by communicating the configuration information identifying whether the network entity 105-b is available for communicating during one or more time resources, the described techniques can be used to improve power savings at the network entity 105-b and limit and impact of the network entity 105-b transitioning to an inactive mode on scheduled communications.

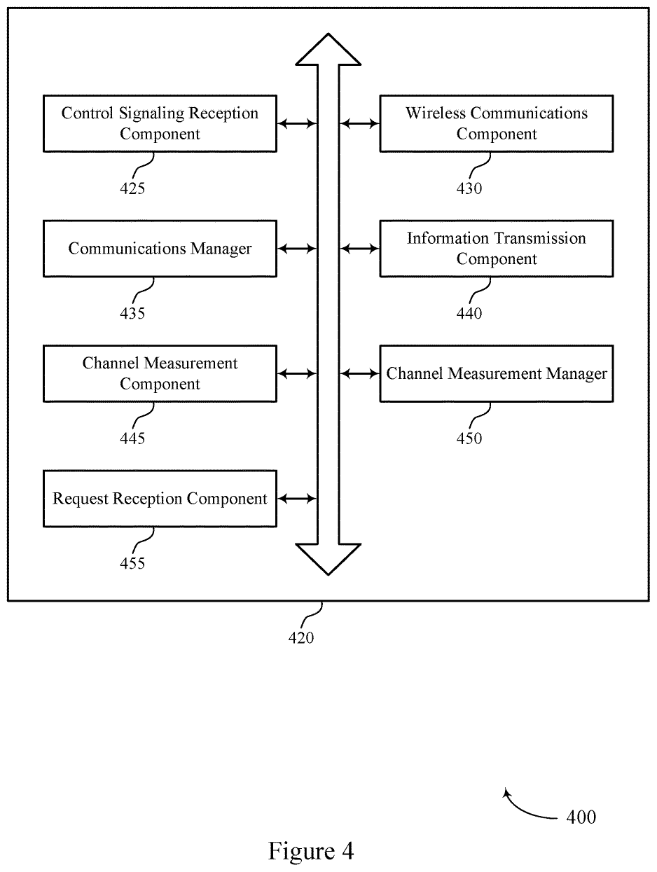

FIG. 4 shows an example 400 of a processing system 420 that supports flexible network entity sleep indications in wireless communications systems. A processing system 420 may be an example of a processing system 140 (such as of a UE 115) and may include a control signaling reception component 425, a wireless communications component 430, a communications manager 435, an information transmission component 440, a channel measurement component 445, a channel measurement manager 450, a request reception component 455, or any combination thereof. A processing system 420, or various component thereof, may be an example of means for performing (such as a means for causing a UE 115 to perform) various techniques described herein.

The control signaling reception component 425 may be configured to cause the UE 115 to receive first control signaling indicating a set of multiple time resources for communicating with a network entity. In some examples, the control signaling reception component 425 may be configured to cause the UE 115 to receive second control signaling indicating one or more time resources of the set of multiple time resources in which the network entity is operating in a reduced capability state and indicating configuration information that identifies whether the network entity is available for communicating during the one or more time resources. The wireless communications component 430 may be configured to cause the UE 115 to communicate one or more messages with the network entity during at least a subset of the set of multiple time resources in accordance with the second control signaling.

In some examples, the second control signaling includes a first control message that indicates the configuration information; or the second control signaling includes a second control message that schedules the one or more messages and indicates the configuration information.

In some examples, the first control signaling indicates, for a first time resource of the plurality of time resources, first configuration information indicating a first availability of the network entity during the first time resource and the second control signaling indicates, for the first time resource, second configuration information indicating a second availability of the network entity during the first time resource, and, to support communicating the one or more messages with the network entity, the wireless communications component 430 may be configured to cause the UE 115 to communicate the one or more messages with the network entity during the first time resource in accordance with the second availability based on the second configuration information indicating to override the first configuration information.

In some examples, the control signaling reception component 425 may be configured to cause the UE 115 to receive, prior to reception of the second control signaling, third control signaling including second configuration information indicating a first availability of the network entity during a first time resource of the one or more time resources, where: the second control signaling indicates, for the first time resource, a second availability of the network entity during the first time resource; and the second control signaling includes a priority flag indicating whether the second availability of the network entity overrides the first availability of the network entity during the first time resource.

In some examples, the configuration information indicates, for a first time resource of the one or more time resources, whether at least a portion of uplink signaling, at least a portion of downlink signaling, or both, are supported or are not supported during the first time resource.

In some examples, the configuration information indicates, for a first time resource of the one or more time resources, that the network entity is unavailable during at least a portion of the first time resource, and, to support communicating the one or more messages with the network entity, the wireless communications component 430 may be configured to cause the UE 115 to communicate a first message scheduled during the first time resource based on one or more rules for communicating signaling when the network entity is unavailable.

In some examples, the one or more rules are based on a type of the first message, a duration of the first message, a type of the second control signaling, a duration that the network entity is unavailable, a portion of the first message that overlaps with at least the portion of the first time resource that the network entity is unavailable, a location within the first time resource that the network entity is unavailable, or any combination thereof.

In some examples, the configuration information indicates, for a first time resource of the one or more time resources, that the network entity is unavailable during at least a portion of the first time resource, and the communications manager 435 may be configured to cause the UE 115 to cancel a feedback message scheduled for the first time resource based on the configuration information indicating that the network entity is unavailable during at least the portion of the first time resource, where, to support communicating the one or more messages with the network entity, the wireless communications component 430 may be configured to cause the UE 115 to transmit the feedback message during a second time resource of the set of multiple time resources based on the configuration information indicating that the network entity is available during the second time resource.

In some examples, the request reception component 455 may be configured to cause the UE 115 to receive a request to communicate the feedback message and scheduling information for the feedback message based on the feedback message being canceled, where the feedback message is transmitted based on the request and in accordance with the scheduling information.

In some examples, the first control signaling indicates, for a first time resource of the set of multiple time resources, a slot offset for the first time resource, a starting symbol for the first time resource, a duration for the first time resource, a periodicity of the first time resource, or any combination thereof.

In some examples, the first control signaling, or the second control signaling, or both indicate, for a first time resource of the set of multiple time resources, one or more frequency resources for communicating during the first time resource, one or more beams for communicating during the first time resource, one or more transmission-reception points for communicating during the first time resource, or any combination thereof.

In some examples, the configuration information indicates, for a first time resource of the one or more time resources, whether transmissions, receptions, or both are active at the network entity during the first time resource, whether one or more beams are active for communicating during the first time resource, whether one or more transmission-reception points of the network entity are active for communicating during the first time resource, or any combination thereof.

In some examples, to support receiving the second control signaling, the control signaling reception component 425 may be configured to cause the UE 115 to receive the second control signaling via a broadcast channel. In some examples, to support receiving the second control signaling, the control signaling reception component 425 may be configured to cause the UE 115 to receive the second control signaling via a sequence of symbols or a reference signal. In some examples, to support receiving the second control signaling, the control signaling reception component 425 may be configured to cause the UE 115 to receive the second control signaling that is modulated according to an on-off keying modulation scheme. In some examples, to support receiving the second control signaling, the control signaling reception component 425 may be configured to cause the UE 115 to receive the second control signaling via a downlink control information message, a media access control-control element, or a radio resource control signal; or any combination thereof.

In some examples, to support receiving the second control signaling, the control signaling reception component 425 may be configured to cause the UE 115 to receive the second control signaling from a second network entity, where the second network entity is a neighbor to the network entity.

In some examples, the information transmission component 440 may be configured to cause the UE 115 to transmit information indicative of the first control signaling, the second control signaling, or both to one or more second UEs based on reception of the second control signaling.

In some examples, the channel measurement component 445 may be configured to cause the UE 115 to perform, prior to reception of the second control signaling, one or more measurements during a first time resource of the one or more time resources. In some examples, the channel measurement manager 450 may be configured to cause the UE 115 to discard the one or more measurements based on the configuration information indicating that the network entity is unavailable during the first time resource.

In some examples, the wireless communications component 430 may be configured to cause the UE 115 to communicate, prior to reception of the second control signaling, the one or more messages during a first time resource of the one or more time resources, and, to support communicating the one or more messages with the network entity includes, the wireless communications component 430 may be configured to cause the UE 115 to communicate the one or more messages during a second time resource of the set of multiple time resources based on the configuration information indicating that the network entity is unavailable during the first time resource and the configuration information indicating that the network entity is available during the second time resource.

In some examples, the configuration information indicates, for a first time resource of the one or more time resources, whether the network entity is available for communicating low-power signaling.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for reducing power expenditure at a network entity and enhancing flexibility of signaling sleep durations of the network entity by indicating sleep durations in control signaling.

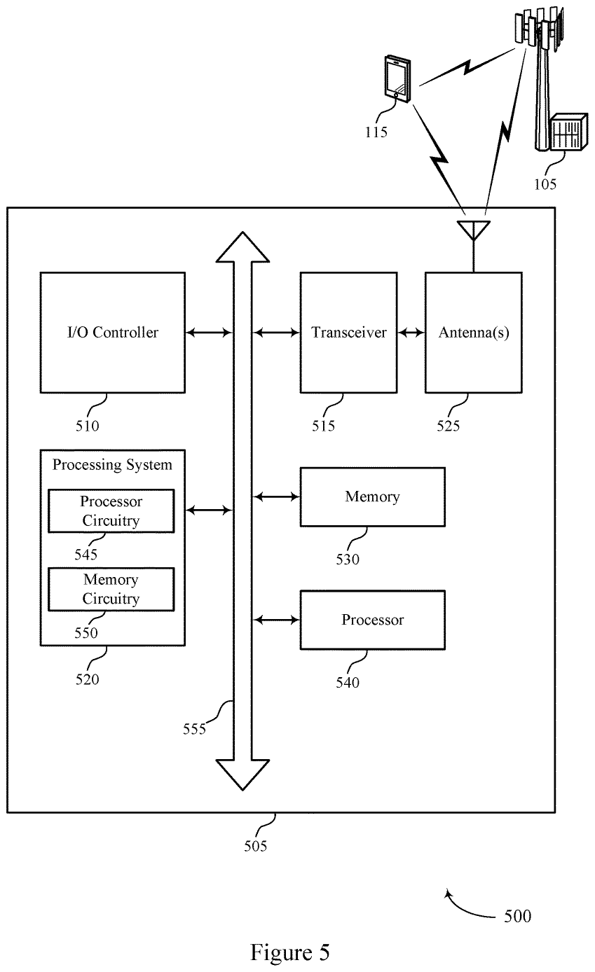

FIG. 5 shows an example of a system 500 including a device 505 that supports flexible network entity sleep indications in wireless communications systems. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 420. For example, the processing system 520 may include processor circuitry 545 and memory circuitry 550 that stores code, and may be configured to cause the device 505 to perform operations that support flexible network entity sleep indications in wireless communications systems. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for reducing power expenditure at a network entity and enhancing flexibility of signaling sleep durations of the network entity by indicating sleep durations in control signaling.

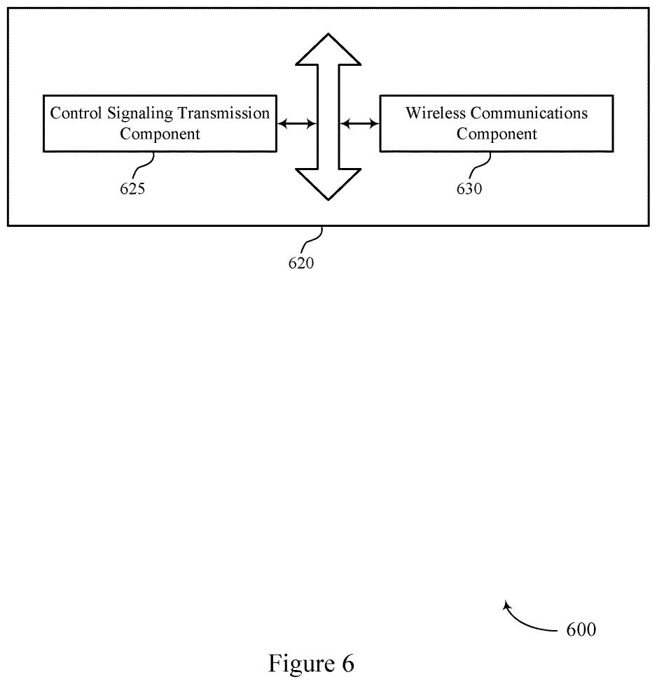

FIG. 6 shows an example 600 of a processing system 620 that supports flexible network entity sleep indications in wireless communications systems. A processing system 620 may be an example of a processing system 145 (such as network entity 105) and may include a control signaling transmission component 625 a wireless communications component 630, or any combination thereof. A processing system 620, or various component thereof, may be an example of means for performing (such as a means for causing a network entity 105 to perform) various techniques described herein.

The control signaling transmission component 625 may be configured to cause the network entity 105 to transmit first control signaling indicating a set of multiple time resources for communications at the network entity. In some examples, the control signaling transmission component 625 may be configured to cause the network entity 105 to transmit second control signaling indicating one or more time resources of the set of multiple time resources in which the network entity is operating in a reduced capability state and indicating configuration information that identifies whether the network entity is available for communicating during the one or more time resources. The wireless communications component 630 may be configured to cause the network entity 105 to communicate one or more messages during at least a subset of the set of multiple time resources in accordance with the second control signaling.

In some examples, the first control signaling indicates, for a first time resource of the plurality of time resources, first configuration information indicating a first availability of the network entity during the first time resource and the second control signaling indicates, for the first time resource, second configuration information indicating a second availability of the network entity during the first time resource, and, to support communicating the one or more messages, the wireless communications component 630 may be configured to cause the network entity 105 to communicate the one or more messages during the first time resource in accordance with the second availability based on the second configuration information indicating to override the first configuration information.

In some examples, the control signaling transmission component 625 may be configured to cause the network entity 105 to transmit, prior to reception of the second control signaling, third control signaling including second configuration information indicating a first availability of the network entity during a first time resource of the one or more time resources, where: the second control signaling indicates, for the first time resource, a second availability of the network entity during the first time resource; and the second control signaling includes a priority flag indicating whether the second availability of the network entity overrides the first availability of the network entity during the first time resource.

In some examples, to support transmitting the second control signaling, the control signaling transmission component 625 may be configured to cause the network entity 105 to transmit the second control signaling via a broadcast channel. In some examples, to support transmitting the second control signaling, the control signaling transmission component 625 may be configured to cause the network entity 105 to transmit, via a low-power radio of the network entity, the second control signaling that is modulated according to an on-off keying modulation scheme.

A processing system 620 may include or be an example of one or more chips, SoCs, chipsets, packages, components, or devices that individually or collectively constitute or include a processing system. A processing system 620 may interface with other components of a network entity 105. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a network entity 105). Operations described herein with reference to the processing system 620, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 620 for operation in a processing system 620 as described herein, the processing system 620 may support techniques for reducing power expenditure at a network entity and enhancing flexibility of signaling sleep durations of the network entity by indicating sleep durations in control signaling.

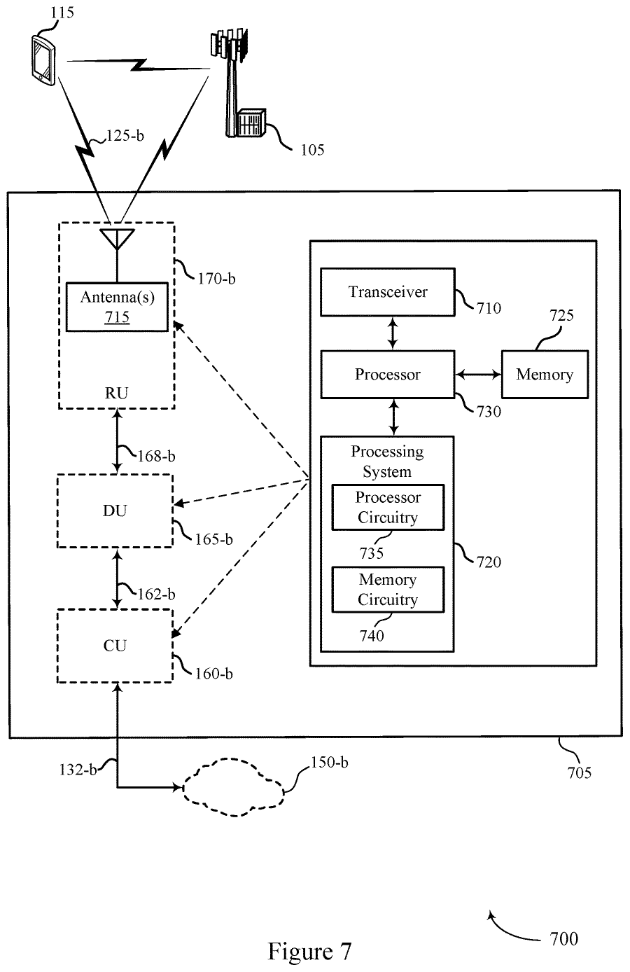

FIG. 7 shows an example of a system 700 including a device 705 that supports flexible network entity sleep indications in wireless communications systems. The device 705 may communicate (such as via one or more wired interfaces or one or more wireless interfaces) with other network devices or network equipment such as a core network 150-b, other network entities 105, UEs 115, or any combination thereof. The device 705 may include components for transmitting and receiving communication, which may include a processing system 720, a transceiver 710, antenna(s) 715, a memory 725, and a processor 730. Components of the device 705 may be coupled (such as operatively, communicatively, functionally, electronically, electrically, in electronic communication) via one or more interfaces.

The transceiver 710 may communicate bi-directionally with another transceiver via wired or wireless links, and may support transmission operations, reception operations, or both, as described herein. The transceiver 710 may include a modem to modulate and demodulate signals, to provide the modulated signals for transmission (such as via antenna(s) 715, via a wired interface), and to demodulate received signals (such as received via antenna(s) 715, received via a wired interface). The transceiver 710 may be operable to support communication via one or more communication links (such as a communication link 125-b, a backhaul link 132-b, a midhaul link 162-b, fronthaul link 168-b).

The processor 730 may be a general-purpose processing component that supports various operations (such as applications) of the device 705. The memory 725 may be a general-purpose storage component that stores code executable by the processor 730. Such code may include instructions that, when executed by the processor 730, cause the device 705 to perform various functions (such as to support an application of the device 705).

For examples in which the device 705 is a network entity 105 in a disaggregated architecture, one or more components of the device 705 may be located at one or more of a CU 160-b, a DU 165-b, or an RU 170-b, one or more of which may include aspects of the processing system 720, the processor 730, the memory 725, or the transceiver 710. Functions of the device 705 may be performed at different components or an operation may be divided between different components (such as different functions being supported by aspects of the CU 160-b, the DU 165-b, or the RU 170-b, the transceiver 710, the processor 730, the memory 725, the processing system 720, or any combination thereof). For example, the processing system 720 may be a component of one or more of the CU 160-b, the DU 165-b, or the RU 170-b. In some examples, interfaces between components of device 705 (such as CU 160-b, DU 165-b, RU 170-b) may support communication at a protocol layer or between protocol layers of a protocol stack.

In some examples, the processing system 720 may manage aspects of communication with the core network 150-b (such as via a backhaul link 132). For example, the processing system 720 may manage the transfer of data communication for UEs 115 with a gateway of the core network 150-b. In some examples, the processing system 720 may manage communication with one or more other network entities 105 and may include a controller or scheduler for controlling communication with UEs 115 (such as in cooperation with the one or more other network entities 105). In some examples, the processing system 720 may support an interface (such as X2 interface, Xn interface) to provide communication between network entities 105.

The processing system 720 may be an example of a processing system 145 or a processing system 620. For example, the processing system 720 may include processor circuitry 735 and memory circuitry 740 that stores code, and the processing system 720 may be configured to cause the device 705 to perform operations that support flexible network entity sleep indications in wireless communications systems. Although the processing system 720 is illustrated as a separate component, which may involve a separate chip, chipset, or other module, in some implementations, one or more functions described with reference to the processing system 720 may be supported by or performed by a transceiver 710, antenna(s) 715, a processor 730, memory 725, or any combination thereof, such that a processing system 720 may include one or more of a transceiver 710, antenna(s) 715, a processor 730, memory 725, or any combination thereof. Further, processor circuitry 735 and memory circuitry 740 each may be implemented at the device 705 in accordance with an aggregated architecture, or the processor circuitry 735 and the memory circuitry 740 may be implemented at one or more of a CU 160-b, a DU 165-b, or an RU 170-b in accordance with a disaggregated architecture.

By including or configuring the processing system 720 for operation in the device 705 as described herein, may support techniques for reducing power expenditure at a network entity and enhancing flexibility of signaling sleep durations of the network entity by indicating sleep durations in control signaling

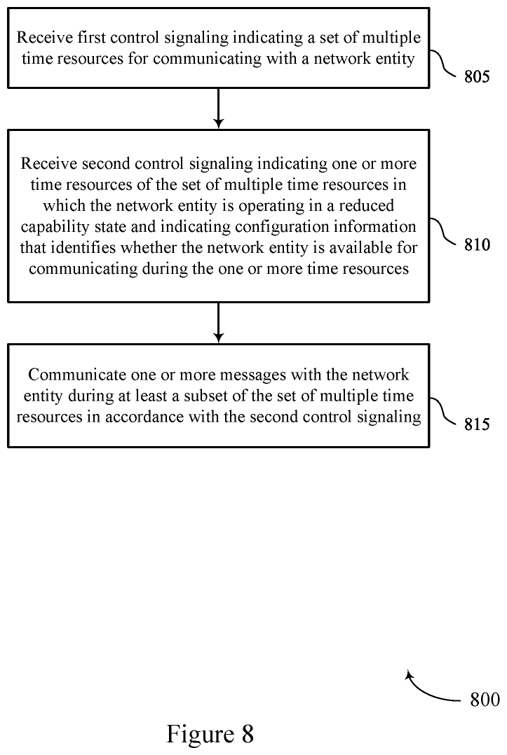

FIG. 8 shows an example of a method 800 that supports flexible network entity sleep indications in wireless communications systems. Operations of the method 800 may be performed by a UE or its components (such as using a processing system configured to cause the UE 115 to perform one or more of the operations) as described herein.

At 805, the method may include receiving first control signaling indicating a set of multiple time resources for communicating with a network entity. In some examples, aspects of the operations of 805 may be performed by a control signaling reception component 425.

At 810, the method may include receiving second control signaling indicating one or more time resources of the set of multiple time resources in which the network entity is operating in a reduced capability state and indicating configuration information that identifies whether the network entity is available for communicating during the one or more time resources. In some examples, aspects of the operations of 810 may be performed by a control signaling reception component 425.

At 815, the method may include communicating one or more messages with the network entity during at least a subset of the set of multiple time resources in accordance with the second control signaling. In some examples, aspects of the operations of 815 may be performed by a wireless communications component 430.

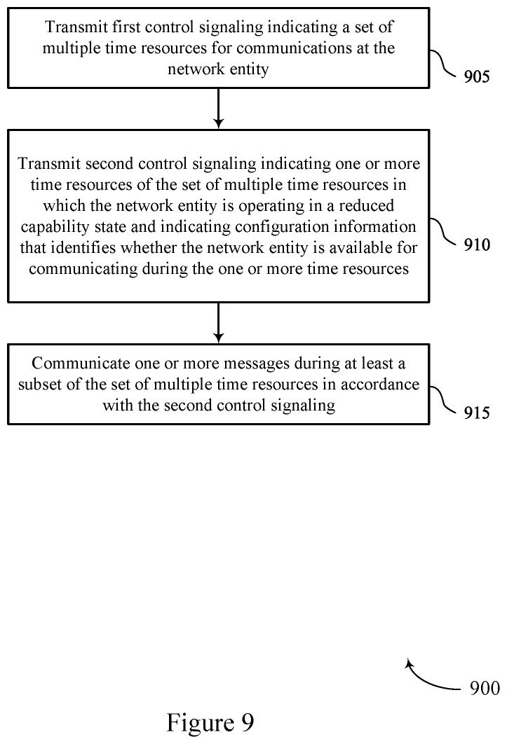

FIG. 9 shows an example of a method 900 that supports flexible network entity sleep indications in wireless communications systems. Operations of the method 900 may be performed by a network entity 105 or its components (such as using a processing system configured to cause the network entity to perform one or more operations) as described herein.

At 905, the method may include transmitting first control signaling indicating a set of multiple time resources for communications at the network entity. In some examples, aspects of the operations of 905 may be performed by a control signaling transmission component 625.

At 910, the method may include transmitting second control signaling indicating one or more time resources of the set of multiple time resources in which the network entity is operating in a reduced capability state and indicating configuration information that identifies whether the network entity is available for communicating during the one or more time resources. In some examples, aspects of the operations of 910 may be performed by a control signaling transmission component 625.

At 915, the method may include communicating one or more messages during at least a subset of the set of multiple time resources in accordance with the second control signaling. In some examples, aspects of the operations of 915 may be performed by a wireless communications component 630.

Implementation examples are described in the following numbered clauses:

Aspect 1: A method for wireless communications by a UE, comprising: receiving first control signaling indicating a plurality of time resources for communicating with a network entity; receiving second control signaling indicating one or more time resources of the plurality of time resources in which the network entity is operating in a reduced capability state and indicating configuration information that identifies whether the network entity is available for communicating during the one or more time resources; and communicating one or more messages with the network entity during at least a subset of the plurality of time resources in accordance with the second control signaling.

Aspect 2: The method of aspect 1, wherein the second control signaling comprises a first control message that indicates the configuration information; or the second control signaling comprises a second control message that schedules the one or more messages and indicates the configuration information.

Aspect 3: The method of any of aspects 1 through 2, wherein the first control signaling indicates, for a first time resource of the plurality of time resources, first configuration information indicating a first availability of the network entity during the first time resource and the second control signaling indicates, for the first time resource, second configuration information indicating a second availability of the network entity during the first time resource, and wherein communicating the one or more messages with the network entity comprises: communicating the one or more messages with the network entity during the first time resource in accordance with the second availability based at least in part on the second configuration information indicating to override the first configuration information.

Aspect 4: The method of any of aspects 1 through 3, further comprising: receiving, prior to reception of the second control signaling, third control signaling comprising second configuration information indicating a first availability of the network entity during a first time resource of the one or more time resources, wherein: the second control signaling indicates, for the first time resource, a second availability of the network entity during the first time resource; and the second control signaling comprises a priority flag indicating whether the second availability of the network entity overrides the first availability of the network entity during the first time resource.

Aspect 5: The method of any of aspects 1 through 4, wherein the configuration information indicates, for a first time resource of the one or more time resources, whether at least a portion of uplink signaling, at least a portion of downlink signaling, or both, are supported or are not supported during the first time resource.

Aspect 6: The method of any of aspects 1 through 5, wherein the configuration information indicates, for a first time resource of the one or more time resources, that the network entity is unavailable during at least a portion of the first time resource, and wherein communicating the one or more messages with the network entity comprises: communicating a first message scheduled during the first time resource based at least in part on one or more rules for communicating signaling when the network entity is unavailable.

Aspect 7: The method of aspect 6, wherein the one or more rules are based at least in part on a type of the first message, a duration of the first message, a type of the second control signaling, a duration that the network entity is unavailable, a portion of the first message that overlaps with at least the portion of the first time resource that the network entity is unavailable, a location within the first time resource that the network entity is unavailable, or any combination thereof.

Aspect 8: The method of any of aspects 1 through 7, wherein the configuration information indicates, for a first time resource of the one or more time resources, that the network entity is unavailable during at least a portion of the first time resource, the method further comprising: canceling a feedback message scheduled for the first time resource based at least in part on the configuration information indicating that the network entity is unavailable during at least the portion of the first time resource, wherein communicating the one or more messages with the network entity comprises: transmitting the feedback message during a second time resource of the plurality of time resources based at least in part on the configuration information indicating that the network entity is available during the second time resource.

Aspect 9: The method of aspect 8, further comprising: receiving a request to communicate the feedback message and scheduling information for the feedback message based at least in part on the feedback message being canceled, wherein the feedback message is transmitted based at least in part on the request and in accordance with the scheduling information.

Aspect 10: The method of any of aspects 1 through 9, wherein the first control signaling indicates, for a first time resource of the plurality of time resources, a slot offset for the first time resource, a starting symbol for the first time resource, a duration for the first time resource, a periodicity of the first time resource, or any combination thereof.

Aspect 11: The method of any of aspects 1 through 10, wherein the first control signaling, or the second control signaling, or both indicate, for a first time resource of the plurality of time resources, one or more frequency resources for communicating during the first time resource, one or more beams for communicating during the first time resource, one or more transmission-reception points for communicating during the first time resource, or any combination thereof.

Aspect 12: The method of any of aspects 1 through 11, wherein the configuration information indicates, for a first time resource of the one or more time resources, whether transmissions, receptions, or both are active at the network entity during the first time resource, whether one or more beams are active for communicating during the first time resource, whether one or more transmission-reception points of the network entity are active for communicating during the first time resource, or any combination thereof.

Aspect 13: The method of any of aspects 1 through 12, wherein receiving the second control signaling comprises: receiving the second control signaling via a broadcast channel; receiving the second control signaling via a sequence of symbols or a reference signal; receiving the second control signaling that is modulated according to an on-off keying modulation scheme; receiving the second control signaling via a downlink control information message, a media access control-control element, or a radio resource control signal; or any combination thereof.

Aspect 14: The method of any of aspects 1 through 13, wherein receiving the second control signaling comprises: receiving the second control signaling from a second network entity, wherein the second network entity is a neighbor to the network entity.

Aspect 15: The method of any of aspects 1 through 14, further comprising: transmitting information indicative of the first control signaling, the second control signaling, or both to one or more second UEs based at least in part on reception of the second control signaling.

Aspect 16: The method of any of aspects 1 through 15, further comprising: performing, prior to reception of the second control signaling, one or more measurements during a first time resource of the one or more time resources; and discarding the one or more measurements based at least in part on the configuration information indicating that the network entity is unavailable during the first time resource.

Aspect 17: The method of any of aspects 1 through 16, further comprising: communicating, prior to reception of the second control signaling, the one or more messages during a first time resource of the one or more time resources, wherein communicating the one or more messages with the network entity comprises: communicating the one or more messages during a second time resource of the plurality of time resources based at least in part on the configuration information indicating that the network entity is unavailable during the first time resource and the configuration information indicating that the network entity is available during the second time resource.

Aspect 18: The method of any of aspects 1 through 17, wherein the configuration information indicates, for a first time resource of the one or more time resources, whether the network entity is available for communicating low-power signaling.

Aspect 19: A method for wireless communications by a network entity, comprising: transmitting first control signaling indicating a plurality of time resources for communications at the network entity; transmitting second control signaling indicating one or more time resources of the plurality of time resources in which the network entity is operating in a reduced capability state and indicating configuration information that identifies whether the network entity is available for communicating during the one or more time resources; and communicating one or more messages during at least a subset of the plurality of time resources in accordance with the second control signaling.

Aspect 20: The method of aspect 19, wherein the first control signaling indicates, for a first time resource of the plurality of time resources, first configuration information indicating a first availability of the network entity during the first time resource and the second control signaling indicates, for the first time resource, second configuration information indicating a second availability of the network entity during the first time resource, and wherein communicating the one or more messages comprises: communicating the one or more messages during the first time resource in accordance with the second availability based at least in part on the second configuration information indicating to override the first configuration information.

Aspect 21: The method of any of aspects 19 through 20, further comprising: transmitting, prior to reception of the second control signaling, third control signaling comprising second configuration information indicating a first availability of the network entity during a first time resource of the one or more time resources, wherein: the second control signaling indicates, for the first time resource, a second availability of the network entity during the first time resource; and the second control signaling comprises a priority flag indicating whether the second availability of the network entity overrides the first availability of the network entity during the first time resource.

Aspect 22: The method of any of aspects 19 through 21, wherein transmitting the second control signaling comprises: transmitting the second control signaling via a broadcast channel; or transmitting, via a low-power radio of the network entity, the second control signaling that is modulated according to an on-off keying modulation scheme.

Aspect 23: A UE for wireless communications, comprising a processing system that includes processor circuitry and memory circuitry that stores code, the processing system configured to cause the UE to perform a method of any of aspects 1 through 18.

Aspect 24: A UE for wireless communications, comprising at least one means for performing a method of any of aspects 1 through 18.

Aspect 25: A non-transitory computer-readable medium storing code for wireless communications, the code comprising instructions executable by one or more processors to perform a method of any of aspects 1 through 18.

Aspect 26: A network entity for wireless communications, comprising a processing system that includes processor circuitry and memory circuitry that stores code, the processing system configured to cause the network entity to perform a method of any of aspects 19 through 22.

Aspect 27: A network entity for wireless communications, comprising at least one means for performing a method of any of aspects 19 through 22.

Aspect 28: A non-transitory computer-readable medium storing code for wireless communications, the code comprising instructions executable by one or more processors to perform a method of any of aspects 19 through 22.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling indicating a plurality of time resources for communicating with a network entity;
receive second control signaling indicating one or more time resources of the plurality of time resources in which the network entity is operating in a reduced capability state and indicating configuration information that identifies whether the network entity is available for communicating during the one or more time resources; and
communicate one or more messages with the network entity during at least a subset of the plurality of time resources in accordance with the second control signaling.

2. The UE of claim 1, wherein:
the second control signaling comprises a first control message that indicates the configuration information; or
the second control signaling comprises a second control message that schedules the one or more messages and indicates the configuration information.

3. The UE of claim 1, wherein the first control signaling indicates, for a first time resource of the plurality of time resources, first configuration information indicating a first availability of the network entity during the first time resource and the second control signaling indicates, for the first time resource, second configuration information indicating a second availability of the network entity during the first time resource, and wherein, to communicate the one or more messages with the network entity, the one or more processors are individually or collectively operable to execute the code to cause the UE to:
communicate the one or more messages with the network entity during the first time resource in accordance with the second availability based at least in part on the second configuration information indicating to override the first configuration information.

4. The UE of claim 1, wherein the one or more processors are individually or collectively further operable to execute the code to cause the UE to:
receive, prior to reception of the second control signaling, third control signaling comprising second configuration information indicating a first availability of the network entity during a first time resource of the one or more time resources, wherein: the second control signaling indicates, for the first time resource, a second availability of the network entity during the first time resource; and the second control signaling comprises a priority flag indicating whether the second availability of the network entity overrides the first availability of the network entity during the first time resource.

5. The UE of claim 1, wherein the configuration information indicates, for a first time resource of the one or more time resources, whether at least a portion of uplink signaling, at least a portion of downlink signaling, or both, are supported or are not supported during the first time resource.

6. The UE of claim 1, wherein the configuration information indicates, for a first time resource of the one or more time resources, that the network entity is unavailable during at least a portion of the first time resource, and wherein, to communicate the one or more messages with the network entity, the one or more processors are individually or collectively operable to execute the code to cause the UE to:
communicate a first message scheduled during the first time resource based at least in part on one or more rules for communicating signaling when the network entity is unavailable.

7. The UE of claim 6, wherein the one or more rules are based at least in part on a type of the first message, a duration of the first message, a type of the second control signaling, a duration that the network entity is unavailable, a portion of the first message that overlaps with at least the portion of the first time resource that the network entity is unavailable, a location within the first time resource that the network entity is unavailable, or any combination thereof.

8. The UE of claim 1, wherein the configuration information indicates, for a first time resource of the one or more time resources, that the network entity is unavailable during at least a portion of the first time resource, and wherein the one or more processors are individually or collectively further operable to execute the code to cause the UE to:
cancel a feedback message scheduled for the first time resource based at least in part on the configuration information indicating that the network entity is unavailable during at least the portion of the first time resource, wherein, to communicate the one or more messages with the network entity, the one or more processors are individually or collectively operable to execute the code to cause the UE to:
transmit the feedback message during a second time resource of the plurality of time resources based at least in part on the configuration information indicating that the network entity is available during the second time resource.

9. The UE of claim 1, wherein the first control signaling indicates, for a first time resource of the plurality of time resources, a slot offset for the first time resource, a starting symbol for the first time resource, a duration for the first time resource, a periodicity of the first time resource, or any combination thereof.

10. The UE of claim 1, wherein the first control signaling, or the second control signaling, or both indicate, for a first time resource of the plurality of time resources, one or more frequency resources for communicating during the first time resource, one or more beams for communicating during the first time resource, one or more transmission-reception points for communicating during the first time resource, or any combination thereof.

11. The UE of claim 1, wherein the configuration information indicates, for a first time resource of the one or more time resources, whether transmissions, receptions, or both are active at the network entity during the first time resource, whether one or more beams are active for communicating during the first time resource, whether one or more transmission-reception points of the network entity are active for communicating during the first time resource, or any combination thereof.

12. The UE of claim 1, wherein, to receive the second control signaling, the one or more processors are individually or collectively operable to execute the code to cause the UE to:
receive the second control signaling via a broadcast channel;
receive the second control signaling via a sequence of symbols or a reference signal;
receive the second control signaling that is modulated according to an on-off keying modulation scheme;
receive the second control signaling via a downlink control information message, a media access control-control element, or a radio resource control signal; or
any combination thereof.

13. The UE of claim 1, wherein, to receive the second control signaling, the one or more processors are individually or collectively operable to execute the code to cause the UE to:
receive the second control signaling from a second network entity, wherein the second network entity is a neighbor to the network entity.

14. The UE of claim 1, wherein the one or more processors are individually or collectively further operable to execute the code to cause the UE to:
transmit information indicative of the first control signaling, the second control signaling, or both to one or more second UEs based at least in part on reception of the second control signaling.

15. The UE of claim 1, wherein the one or more processors are individually or collectively further operable to execute the code to cause the UE to:
perform, prior to reception of the second control signaling, one or more measurements during a first time resource of the one or more time resources; and
discard the one or more measurements based at least in part on the configuration information indicating that the network entity is unavailable during the first time resource.

16. A network entity, comprising:
one or more memories storing processor-executable code; and
one or more processors coupled with the one or more memories and individually or collectively operable to execute the code to cause the network entity to:
transmit first control signaling indicating a plurality of time resources for communications at the network entity;
transmit second control signaling indicating one or more time resources of the plurality of time resources in which the network entity is operating in a reduced capability state and indicating configuration information that identifies whether the network entity is available for communicating during the one or more time resources; and
communicate one or more messages during at least a subset of the plurality of time resources in accordance with the second control signaling.

17. The network entity of claim 16, wherein the first control signaling indicates, for a first time resource of the plurality of time resources, first configuration information indicating a first availability of the network entity during the first time resource and the second control signaling indicates, for the first time resource, second configuration information indicating a second availability of the network entity during the first time resource, and wherein, to communicate the one or more messages, the one or more processors are individually or collectively operable to execute the code to cause the network entity to:
communicate the one or more messages during the first time resource in accordance with the second availability based at least in part on the second configuration information indicating to override the first configuration information.

18. The network entity of claim 16, wherein the one or more processors are individually or collectively further operable to execute the code to cause the network entity to:
transmit, prior to reception of the second control signaling, third control signaling comprising second configuration information indicating a first availability of the network entity during a first time resource of the one or more time resources, wherein:
the second control signaling indicates, for the first time resource, a second availability of the network entity during the first time resource; and
the second control signaling comprises a priority flag indicating whether the second availability of the network entity overrides the first availability of the network entity during the first time resource.

19. The network entity of claim 16, wherein, to transmit the second control signaling, the one or more processors are individually or collectively operable to execute the code to cause the network entity to:
transmit the second control signaling via a broadcast channel; or
transmit, via a low-power radio of the network entity, the second control signaling that is modulated according to an on-off keying modulation scheme.

20. A method for wireless communications by a user equipment (UE), comprising:
receiving first control signaling indicating a plurality of time resources for communicating with a network entity;
receiving second control signaling indicating one or more time resources of the plurality of time resources in which the network entity is operating in a reduced capability state and indicating configuration information that identifies whether the network entity is available for communicating during the one or more time resources; and
communicating one or more messages with the network entity during at least a subset of the plurality of time resources in accordance with the second control signaling.
